(19) United States
(12) Patent Application Publication
(10) Pub. No.: US 2023/0334446 A1
(43) Pub. Date: Oct. 19, 2023

(54) METHOD AND SYSTEM OF TRANSACTION SETTLEMENT AND SMART CONTRACT ACCESS USING GUARANTEE TOKENS

(71) Applicant: Mastercard International Incorporated, Purchase, NY (US)

(72) Inventors: Matthew Sebastian Alfonso FERNANDES, London (GB); Oskar DURIS, Walnut Creek, CA (US); Rashi GOYAL, Plainsboro, NJ (US); Arnab MAITY, South Plainfield, NJ (US); Martin ETHERIDGE, Woodford Green (GB)

(21) Appl. No.: 18/134,182

(22) Filed: Apr. 13, 2023

Related U.S. Application Data
(60) Provisional application No. 63/424,242, filed on Nov. 10, 2022.
(60) Provisional application No. 63/330,432, filed on Apr. 13, 2022.

(51) Int. Cl. G06Q 20/10; G06Q 20/36; G06Q 20/38; G06Q 20/12

(52) U.S. Cl. CPC G06Q 20/10; G06Q 20/367; G06Q 20/389; G06Q 20/1235

(57) ABSTRACT

A method for transaction settlement using guarantee tokens includes: receiving a transaction request from a first financial institution including a receiving party digital address, a digital token issued by the first financial institution to the receiving party digital address, a sending party address, an asset network identification, and an asset identification; generating a guarantee token against the digital token; generating an asset request transaction including the guarantee token, the receiving party digital address, the sending party digital address, and the asset identification; transmitting the asset request transaction to the asset network; receiving an asset transaction from the asset network including the asset, the receiving party digital address, and the sending party digital address; generating an asset transfer transaction including the receiving party digital address, the sending party digital address, and the asset identification; and transmitting the asset transaction to the receiving party digital address.

### FIELD

The present disclosure relates to transaction settlement and smart contract access using guarantee tokens or a combination of guarantee tokens and payment status tokens. More particularly, the present disclosure relates to the settlement of digital token transactions for assets secured by one or more smart contracts.

### BACKGROUND

The cryptocurrency market has seen tremendous growth with a market cap of over $1.5 trillion dollars. Until now, the market has largely served cryptocurrency insiders without much benefit in mainstream use cases. Stablecoins, predominantly used for moving into and out of cryptocurrency-trading positions, are moving into mainstream use cases such as remittance, supplier B2B payments and commerce payments. However, stablecoins continue to suffer from several issues including uncertain regulations, fraud and unpredictable costs. At the same time, central banks are exploring Central Bank Digital Currencies (CBDCs), which could provide citizens with a digital version of fiat currency. But movement towards CBDCs are likely to take different paths in each country, take many years to go live, and ultimately may not offer all the potential functionalities of stablecoins. While current solutions still face challenges, blockchain-based payments can have multiple benefits including transparency (e.g., ability for participants to view the status and details of transactions), immutability (e.g., ensuring transactions cannot be changed or deleted by other parties), speed (e.g., potential to achieve faster transactions particularly across borders), cost efficiencies (e.g., reducing manual tasks and streamlining costs associated with cross border money movement), and programmability (e.g., digitally native payment tokens can be coded to execute payments when conditions are met, opening up innovative use cases).

Currently, most of the innovation in cryptocurrency technology focuses on the opportunities presented by decentralized applications and services over those which are centralized. However, there has been little innovation in the cryptocurrency market with a focus on creating a flexible financial infrastructure that satisfies regulatory requirements and expectations, and that delivers consumer protections while maintaining the stability of the current financial system. Thus, there is a need for a novel solution for a regulated payment service that enables the use of digital currencies (e.g., cryptocurrencies) that retains the security features and other benefits of cryptocurrency systems without the associated volatility in value.

### SUMMARY

A method for transaction settlement and smart contract access using guarantee tokens is disclosed. The method including: receiving, by a receiving device of a processing server, a transaction request from a first financial institution, the transaction request including at least an receiving party digital address, a digital token issued by the first financial institution to the receiving party digital address, a sending party address, an asset network identification, and an asset identification; generating, by a generation module of the processing server, a guarantee token against the digital token, the guarantee token being a tokenized guarantee of the digital token issued by the first financial institution; generating, by the generation module of the processing server, an asset request transaction, the asset request transaction including at least the guarantee token, the receiving party digital address, the sending party digital address, and the asset identification; transmitting, by a transmitting device of the processing server, the asset request transaction to the asset network; receiving, by the receiving device of the processing server, an asset transaction from the asset network, the asset transaction including at least the asset, the receiving party digital address, and the sending party digital address; generating, by the generation module of the processing server, an asset transfer transaction, the asset transfer transaction including at least the receiving party digital address, the sending party digital address, and the asset identification; and transmitting, by the transmitting device of the processing server, the asset transfer transaction to the receiving party digital address.

A system for transaction settlement and smart contract access using guarantee tokens is disclosed. The system including: a receiving device of a processing server receiving a transaction request from a first financial institution, the transaction request including at least an receiving party digital address, a digital token issued by the first financial institution to the receiving party digital address, a sending party digital address, an asset network identification, and an asset identification; a generation module of the processing server generating a guarantee token against the digital token, the guarantee token being a tokenized guarantee of the digital token issued by the first financial institution; the generation module of the processing server generating an asset request transaction, the asset request transaction including at least the guarantee token, the receiving party digital address, the sending party digital address, and the asset identification; a transmitting device of the processing server transmitting the asset request transaction to the asset network; the receiving device of the processing server receiving an asset transaction from the asset network, the asset transaction including at least the asset, the receiving party digital address, and the sending party digital address; the generation module of the processing server generating an asset transfer transaction, the asset transfer transaction including at least the receiving party digital address, the sending party digital address, and the asset identification; and the transmitting device of the processing server transmitting the asset transfer transaction to the receiving party digital address.

A method for transaction settlement using guarantee tokens and payment status tokens is disclosed. The method including: receiving, by a receiving device of a processing server, a transaction request from a first financial institution, the transaction request including at least an receiving party digital address, a digital token issued by the first financial institution to the receiving party digital address, a sending party address, an asset network identification, and an asset identification; generating, by a generation module of the processing server, a guarantee token against the digital token, the guarantee token being a tokenized guarantee of the digital token issued by the first financial institution; generating, by the generation module of the processing server, a payment status token, the payment status token being a tokenized payment authorization message of payment for an asset associated with the asset identification; generating, by the generation module of the processing server, an asset request transaction, the asset request transaction including at least the payment status token, the receiving party digital address, the sending party digital address, and the asset identification; transmitting, by a transmitting device of the processing server, the asset request transaction to the asset network; transmitting, by the transmitting device of the processing server, the guarantee token to a second financial institution associated with the sending party address; receiving, by the receiving device of the processing server, an asset transaction from the asset network, the asset transaction including at least the asset, the receiving party digital address, and the sending party digital address; generating, by the generation module of the processing server, an asset transfer transaction, the asset transfer transaction including at least the receiving party digital address, the sending party digital address, and the asset identification; and transmitting, by the transmitting device of the processing server, the asset transaction to the receiving party digital address.

A system for transaction settlement using guarantee tokens and payment status tokens is disclosed. The system including: a receiving device of a processing server receiving a transaction request from a first financial institution, the transaction request including at least an receiving party digital address, a digital token issued by the first financial institution to the receiving party digital address, a sending party digital address, an asset network identification, and an asset identification; a generation module of the processing server generating a guarantee token against the digital token, the guarantee token being a tokenized guarantee of the digital token issued by the first financial institution; the generation module of the processing server generating a payment status token, the payment status token being a tokenized payment authorization message of payment for an asset associated with the asset identification; the generation module of the processing server generating an asset request transaction, the asset request transaction including at least the payment status token, the receiving party digital address, the sending party digital address, and the asset identification; a transmitting device of the processing server transmitting the asset request transaction to the asset network; the transmitting device of the processing server transmitting the guarantee token to a second financial institution associated with the sending party address; the receiving device of the processing server receiving an asset transaction from the asset network, the asset transaction including at least the asset, the receiving party digital address, and the sending party digital address; the generation module of the processing server generating an asset transfer transaction, the asset transfer transaction including at least the receiving party digital address, the sending party digital address, and the asset identification; and the transmitting device of the processing server transmitting the asset transaction to the receiving party digital address.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for transaction settlement and smart contract access using guarantee tokens in accordance with exemplary embodiments.

FIG. 2 is a block diagram illustrating the processing server of the system of FIG. 1 for transaction settlement and smart contract access using guarantee tokens in accordance with exemplary embodiments.

FIGS. 3A-3E is a flow diagram illustrating a process for transaction settlement and smart contract access using guarantee tokens as executed by the processing server of FIG. 2 in the system of FIG. 1 in accordance with exemplary embodiments.

FIGS. 4A-4B is a flow chart illustrating an exemplary method for transaction settlement and smart contract access using guarantee tokens in accordance with exemplary embodiments.

FIGS. 5A-5B is a flow diagram illustrating a process for transaction settlement and smart contract access using guarantee tokens and payment status tokens as executed by the processing server of FIG. 2 in the system of FIG. 1 in accordance with exemplary embodiments.

FIGS. 6A-6B is a flow chart illustrating an exemplary method for transaction settlement and smart contract access using guarantee tokens and payment status tokens in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain— A public ledger of all transactions of a blockchain-based currency. One or more computing devices may comprise a blockchain network, which may be configured to process and record transactions as part of a block in the blockchain. Once a block is completed, the block is added to the blockchain, and the transaction record thereby updated. In many instances, the blockchain may be a ledger of transactions in chronological order or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Transaction Settlement and Smart Contract Access Using Guarantee Tokens

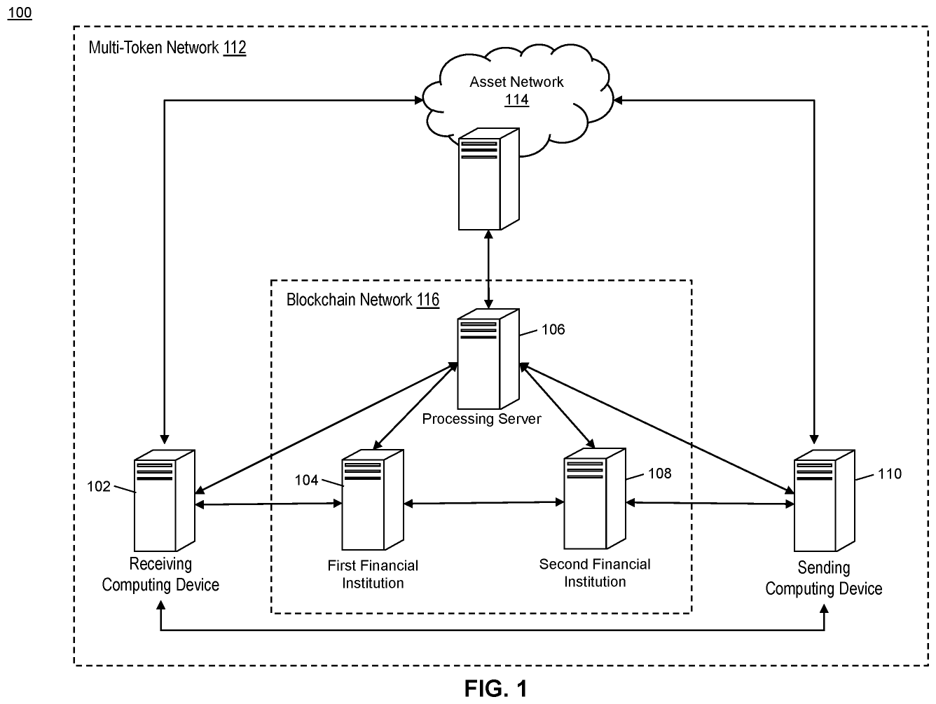

FIG. 1 illustrates a system 100 for transaction settlement and smart contract access using guarantee tokens in accordance with exemplary embodiments.

The system 100 includes a receiving computing device 102, a first financial institution 104, a processing server 106, a second financial institution 108, a sending computing device 110, and an asset network 114.

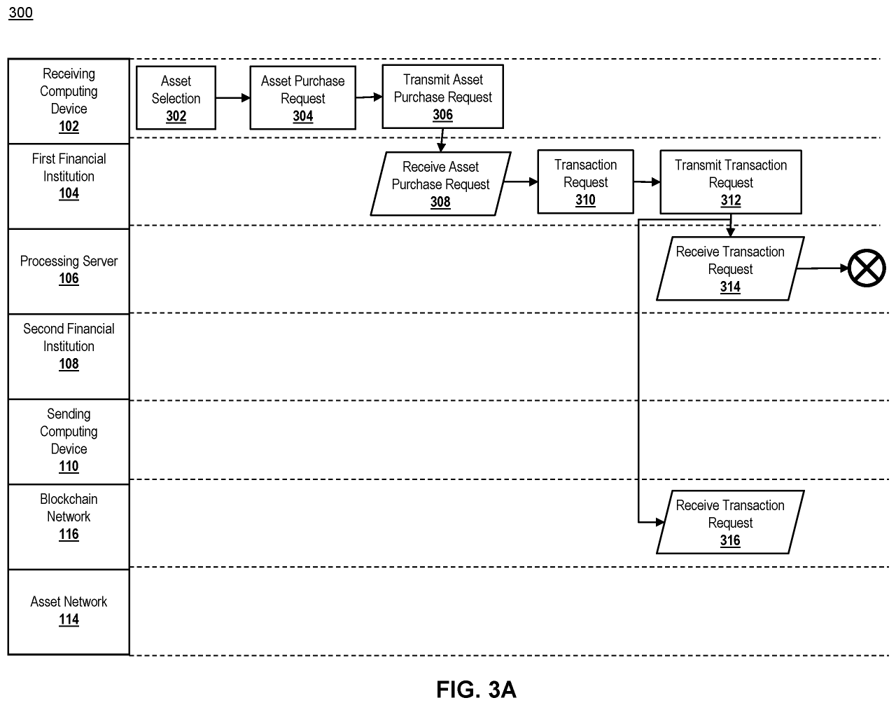

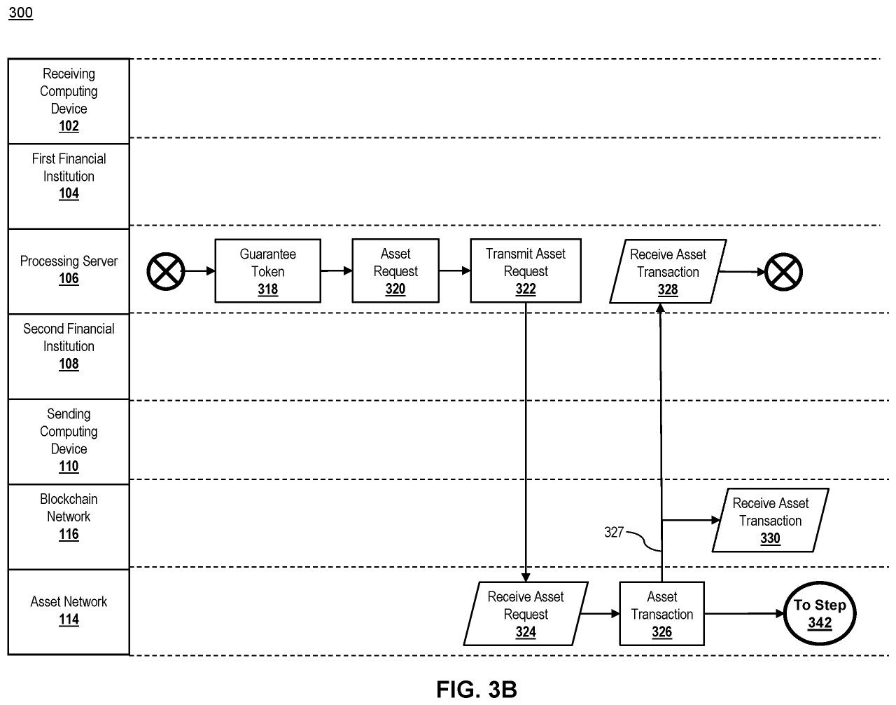

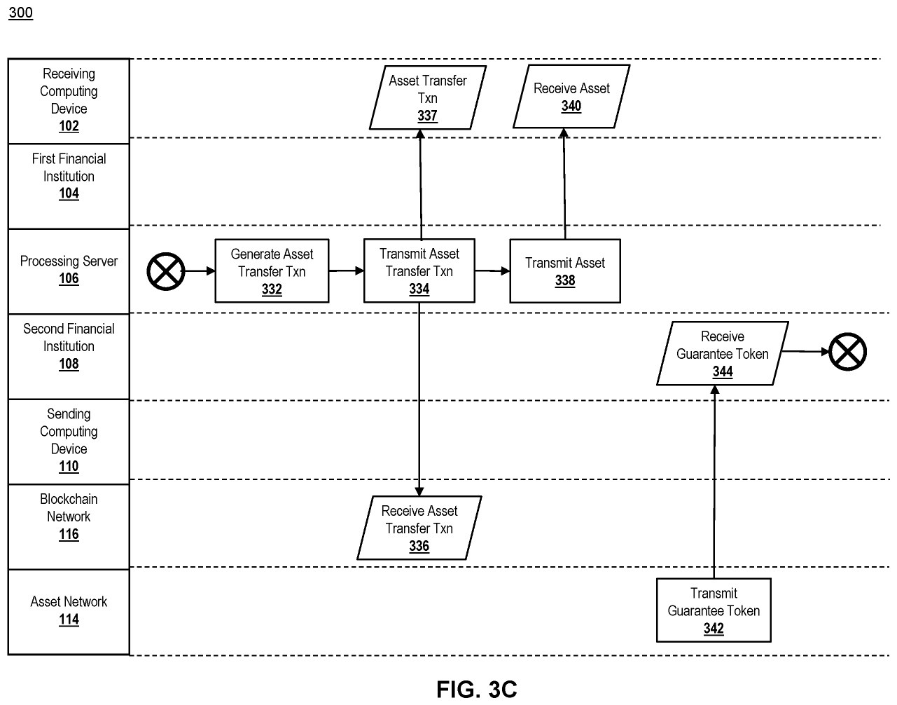

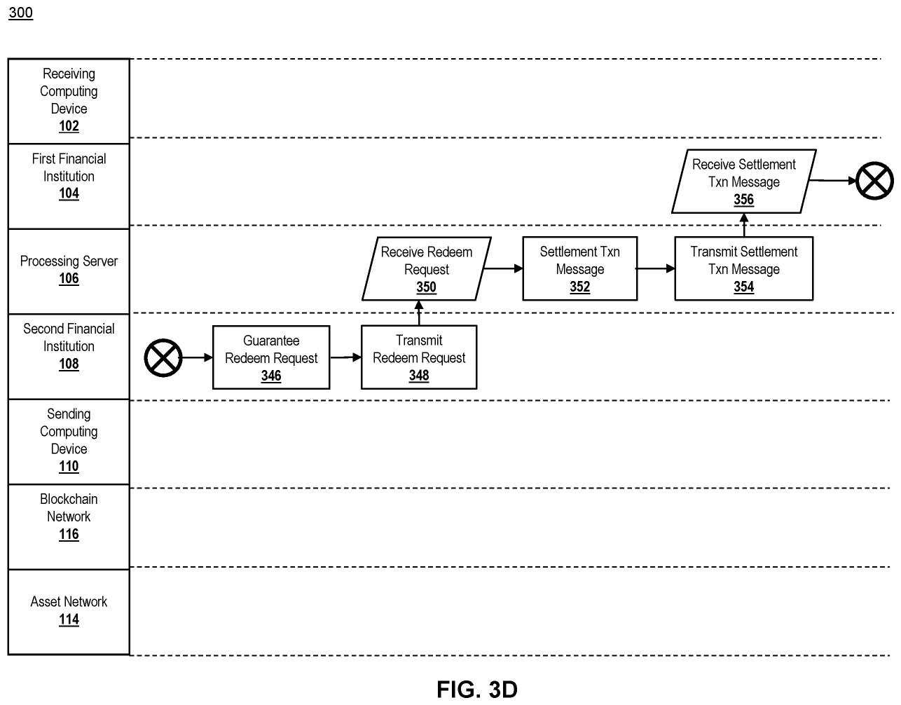

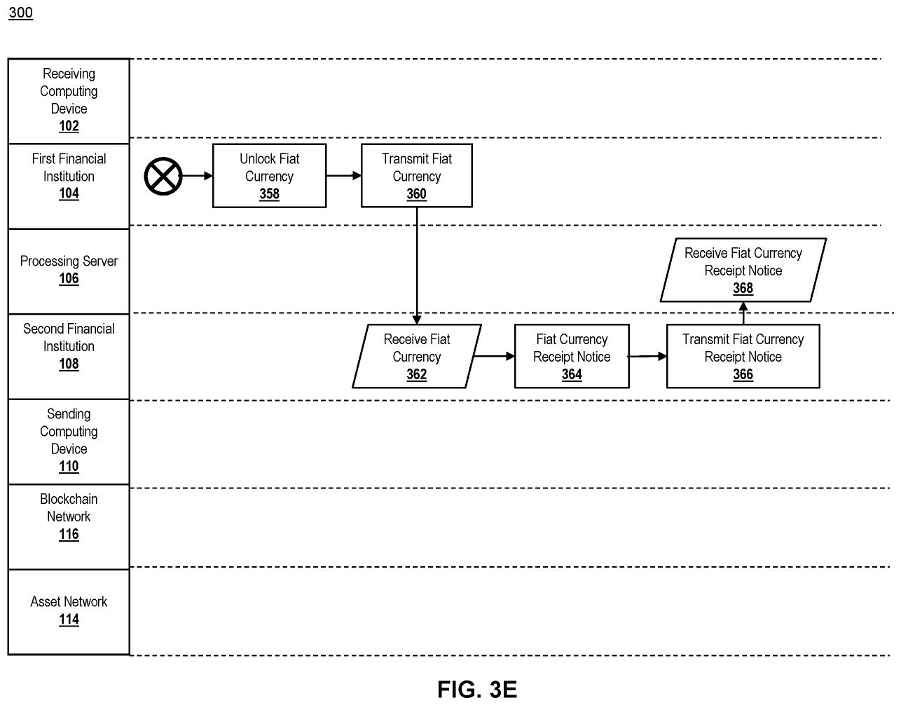

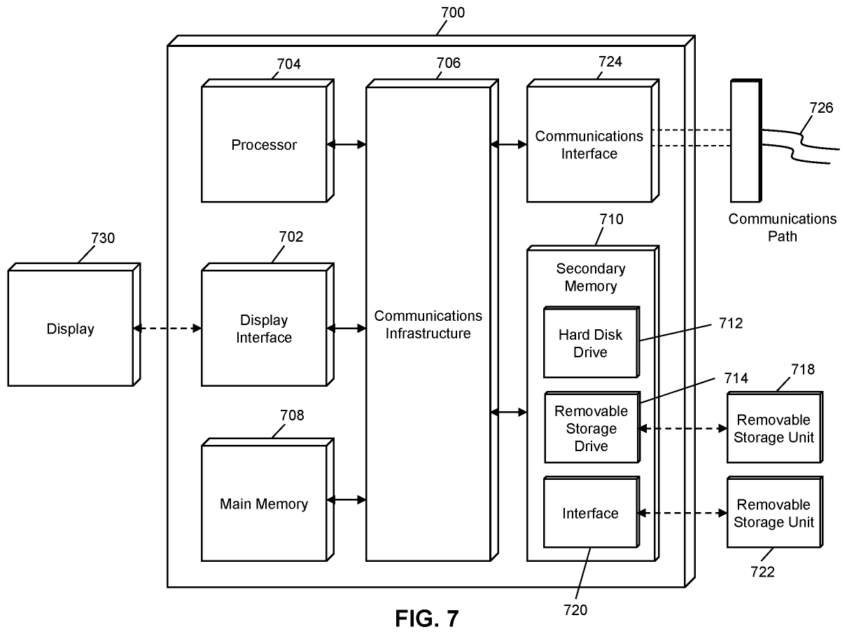

The receiving computing device 102 is a computing device associated with a user in the system 100. In an embodiment, the user of the receiving computing device 102 is a customer of the first financial institution 104 (e.g., has a transaction account with the first financial institution 104). For example, the user of the receiving computing device 102 has a digital address, e.g., a digital wallet, for transacting deposit tokens issued by the first financial institution 104. Further, the receiving computing device 102 operates on the asset network 114. For example, the user of the receiving computing device 102 may have an account with or otherwise access the asset network 114 to purchase one or more assets (e.g., to purchase a Non-Fungible Token or “NFT” on an NFT marketplace). Transactions involving the receiving computing device 102 are described in more detail below with reference to FIGS. 3A-6B. The receiving computing device 102 may be a desktop computer, a notebook, a laptop computer, a tablet computer, a handheld device, a smart-phone, a thin client, or any other electronic device or computing system capable of storing, compiling, and organizing audio, visual, or textual data and receiving and sending that data to and from other computing devices, such as the first financial institution 104, the processing server 106, the sending computing device 110, and/or one or more nodes of the asset network 114. For example, the receiving computing device 102 may be any type of electronic device or computing system specially configured to perform the functions discussed herein, such as the computer system 700 illustrated in FIG. 7. While only a single receiving computing device 102 is illustrated, it can be appreciated that the system 100 can include any number of receiving computing devices 102.

The first financial institution 104 is a financial institution, such as an issuing bank, or any other entity configured to issue transaction accounts that are suitable for funding an electronic payment transaction with a fiat currency or digital tokens. The first financial institution 104 is a financial entity that issues, but is not limited to, Central Bank Digital Currencies (CBDCs), regulated stablecoins, digitized deposit tokens, or any other suitable digital token representing a legal claim on the first financial institution 104. For example, the first financial institution 104 may be, but is not limited to, a bank, a central bank, an electronic currency issuer, a stablecoin issuer, or any other suitable financial entity capable of issuing digital tokens. In an embodiment where the first financial institution 104 is a central bank, the digital tokens represent central bank liabilities (e.g., CBDCs). In an embodiment where the first financial institution 104 is a bank, the digital tokens represent digitized deposits, which is a digitalized form of deposit liabilities. In an embodiment the first financial institution 104 is an electronic currency issuer, the digital tokens represent electronic currency liabilities. In an embodiment where the first financial institution 104 is a stablecoin issuer, the digital tokens represent a legal claim associated with the stablecoin holding. The digital token is a digital representation of the deposit liabilities of the relevant first financial institution 104 such as, but not limited to, a legal claim on the first financial institution 104, a withdrawal claim, a depositor claim, a deposit insurance claim, etc. The underlying deposit and associated features for which the digital token represents does not change because of tokenization. The digital tokens issued by the first financial institution 104 include one or more of, but is not limited to, an amount to be issued (e.g., a digital token fiat currency equivalent), a currency (e.g., the fiat currency the digital token is issued against), an issue date (e.g., the date the digital token is created), and any other suitable metadata, (e.g., identification of the first financial institution 104, identification of the receiving computing device 102, a digital address of the receiving computing device 102, etc.).

The first financial institution 104 may be a permissioned entity on the multi-token network 112 that interacts with the multi-token network 112 and offers customer-facing products such as digital wallets. The first financial institution 104 is permitted to create and manage wallets (e.g., digital addresses) for their customers (e.g., a user of the receiving computing device 102), read transactions and balances from the multi-token network 112, and submit transactions on behalf of their customers (e.g., a user of the receiving computing device 102). Further, the first financial institution 104 may issue a payment instrument to the receiving computing device 102, such as a physical payment card, a virtual payment card, a paper check, a virtual check, etc. The receiving computing device 102 may receive the digital wallets and/or other payment instrument(s) to convey payment credentials associated with the transaction account to fund a payment transaction with that transaction account.

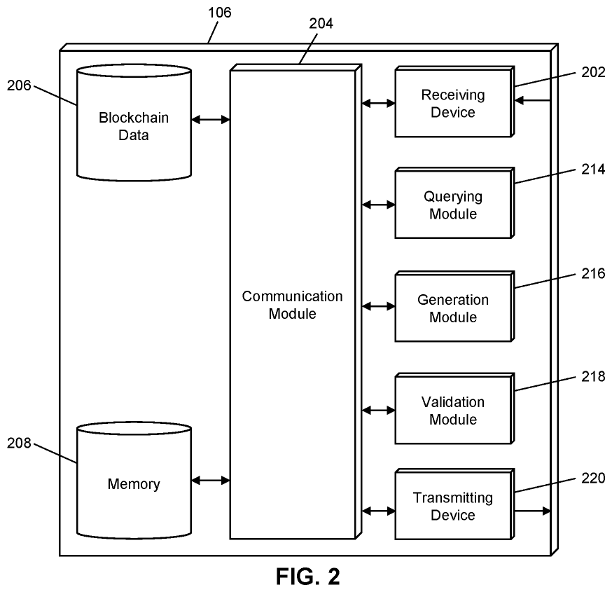

The processing server 106 may be a server, a desktop computer, a notebook, a laptop computer, a tablet computer, a handheld device, a smart-phone, a thin client, or any other electronic device or computing system capable of storing, compiling, and organizing audio, visual, or textual data and receiving and sending that data to and from other computing devices, such as the receiving computing device 102, the first financial institution 104, the second financial institution 108, the sending computing device 110, and/or the asset network 114. For example, the processing server 106 may be any type of electronic device or computing system specially configured to perform the functions discussed herein, such as the computer system 700 illustrated in FIG. 7. In an exemplary embodiment, the processing server 106 is an operator node and/or administrative node on the multi-token network 112 capable of receiving and transmitting digital tokens to and from the first financial institution 104 and the second financial institution 108, generating guarantee tokens against the digital tokens, generating payment status tokens for unlocking one or more smart contracts on the asset network 114, receiving, generating, and/or transmitting transaction messages and requests to and from the receiving computing device 102, the first financial institution 104, the second financial institution 108, the sending computing device 110, and/or the asset network 114, receiving and transmitting assets to and from the asset network 114, the receiving computing device 102, and the sending computing device 110, receiving guarantee token redeem requests from the first financial institution 104 and the second financial institution 108, and generating and transmitting settlement transaction messages to the first financial institution 104 and the second financial institution 108. The processing server 106 is discussed in more detail with reference to FIG. 2.

The second financial institution 108 is a financial institution, such as a receiving bank, or any other entity configured to issue transaction accounts that are suitable for funding an electronic payment transaction with a fiat currency or digital tokens. The second financial institution 108 is a financial entity that issues, but is not limited to, Central Bank Digital Currencies (CBDCs), regulated stablecoins, digitized deposit tokens, or any other suitable digital token representing a legal claim on the second financial institution 108. For example, the second financial institution 108 may be, but is not limited to, a bank, a central bank, an electronic currency issuer, a stablecoin issuer, or any other suitable financial entity capable of issuing digital tokens. In an embodiment where the second financial institution 108 is a central bank, the digital tokens represent central bank liabilities (e.g., CBDCs). In an embodiment where the second financial institution 108 is a bank, the digital tokens represent digitized deposits, which is a digitalized form of deposit liabilities. In an embodiment the second financial institution 108 is an electronic currency issuer, the digital tokens represent electronic currency liabilities. In an embodiment where the second financial institution 108 is a stablecoin issuer, the digital tokens represent a legal claim associated with the stablecoin holding. The digital token is a digital representation of the deposit liabilities of the relevant second financial institution 108 such as, but not limited to, a legal claim on the second financial institution 108, a withdrawal claim, a depositor claim, a deposit insurance claim, etc. The underlying deposit and associated features for which the digital token represents does not change because of tokenization. The digital tokens issued by the second financial institution 108 include one or more of, but is not limited to, an amount to be issued (e.g., a digital token fiat currency equivalent), a currency (e.g., the fiat currency the digital token is issued against), an issue date (e.g., the date the digital token is created), and any other suitable metadata, (e.g., identification of the second financial institution 108, identification of the sending computing device 110, a digital address of the sending computing device 110, etc.).

The second financial institution 108 may be permissioned entity on the multi-token network 112 that interacts with the multi-token network 112 and offers customer-facing products such as digital wallets. The second financial institution 108 is permitted to create and manage wallets (e.g., digital addresses) for their customers (e.g., a user of the sending computing device 110), read transactions and balances from the multi-token network 112, and submit transactions on behalf of their customers (e.g., a user of the sending computing device 110). Further, the second financial institution 108 may issue a payment instrument to the sending computing device 110, such as a physical payment card, a virtual payment card, a paper check, a virtual check, etc. The sending computing device 110 may receive the digital wallets and/or other payment instrument(s) to convey payment credentials associated with the transaction account to fund a payment transaction with that transaction account.

The sending computing device 110 is a computing device associated with a user in the system 100. In an embodiment, the user of the sending computing device 110 is a customer of the second financial institution 108 (e.g., has a transaction account with the first financial institution 104). For example, the user of the sending computing device 110 has a digital address, e.g., a digital wallet, for transacting deposit tokens issued by the second financial institution 108. Further, the sending computing device 110 operates on the asset network 114. For example, the user of the sending computing device 110 may have an account with or otherwise access the asset network 114 through which the user of the sending computing device 110 sells one or more assets (e.g., an NFT on an NFT marketplace). Transactions involving the sending computing device 110 are described in more detail below with reference to FIGS. 3A-6B. The sending computing device 110 may be a desktop computer, a notebook, a laptop computer, a tablet computer, a handheld device, a smart-phone, a thin client, or any other electronic device or computing system capable of storing, compiling, and organizing audio, visual, or textual data and receiving and sending that data to and from other computing devices, such as the receiving computing device 102, the processing server 106, the second financial institution 108, and/or one or more nodes of the asset network 114. For example, the sending computing device 110 may be any type of electronic device or computing system specially configured to perform the functions discussed herein, such as the computer system 700 illustrated in FIG. 7. While only a single sending computing device 110 is illustrated, it can be appreciated that the system 100 can include any number of sending computing devices 110.

The asset network 114 is a network or platform that enables the exchange (e.g., the purchase and sale) of assets (e.g., products or services) between users using digital tokens. The asset network 114 is capable of storing, compiling, and organizing audio, visual, or textual data and receiving and sending that data to and from other computing devices, such as the receiving computing device 102, and/or the processing server 106, the sending computing device 110. For example, the asset network 114 may be operated or supported by any type of electronic device or computing system or plurality of electronic devices or computing systems specially configured to perform the functions discussed herein, such as the computer system 700 illustrated in FIG. 7. The asset network 114 may include a plurality of user nodes (e.g., the receiving computing device 102 and the sending computing device 110) that sell and/or purchase assets on the asset network 114. For example, the asset network 114 may be, but is not limited to, a retail payment network, a business-to-business payment network, a supply chain payment network, a cross-border person-to-person payment network (e.g., remittent flows), a public crypto-economy (e.g., an NFT marketplace, a decentralized finance (DeFi) network, etc.), or any other suitable network for facilitating the exchange of assets for digital tokens as will be apparent to one skilled in the art. In the example of an NFT marketplace, the asset network 114 facilitates the sale and purchase of digital art (e.g., NFTs) between the receiving computing device 102 and the sending computing device 110. Further, the asset network 114 may include one or more smart contracts associated or linked to the assets being bought and sold on the asset network 114 along with one or more parameters for unlocking the smart contract and releasing the asset. In the example of an NFT marketplace (e.g., the asset network 114), a smart contract holds the each of the NFTs for sale (e.g., the asset), and defines one or more parameters for unlocking the smart contract. For example, the one or more parameters of the smart contract may define an acceptable currency for purchase of the asset, etc.

In an embodiment of the system 100, the receiving computing device 102, the first financial institution 104, the processing server 106, the second financial institution 108, and the sending computing device 110 are part of the multi-token network 112. The multi-token network 112 facilitates transactions and communications between and amongst traditional fiat currency users and crypto-native users (e.g., the receiving computing device 102, the first financial institution 104, the second financial institution 108, and the sending computing device 110). The multi-token network 112 enables multiple entities (e.g., companies, governments, financial institutions, etc.) to issue and transfer digital tokens and leverages regulated cryptocurrencies (e.g., stablecoins, CBDCs, etc.) as either token forms for transactions or as assets to deliver instant settlement on the multi-token network 112. The multi-token network 112 interacts with and/or is otherwise integrated with existing traditional payment rails providing additional consumer choice and benefit (e.g., conducting transaction with digital tokens or with fiat currency). The multi-token network 112 is a private permissioned network system that maintains an access control layer to allow selected actions to be performed only by certain identifiable participants (e.g., the receiving computing device 102, the first financial institution 104, the second financial institution 108, and the sending computing device 110). For example, the multi-token network 112 is capable of receiving, storing, processing, and/or transmitting, digital tokens directly from address to address (e.g., a digital address associated with the receiving computing device 102 and a digital address associated with the sending computing device 110). The multi-token network 112 is a programmable network operated on network operator infrastructure and accessible to participants through one or more application programming interfaces (APIs). The APIs may be private and permissioned APIs such that the nodes of the multi-token network 112 require credentials issued by the multi-token network 112 to access the multi-token network 112. For example, the multi-token network 112 includes APIs compatible with each financial institution (e.g., the first financial institution 104 and the second financial institution 108) that participates in the multi-token network 112. The multi-token network 112 is capable of communicating and transacting across multiple networks (e.g., the asset network 114 and the blockchain network 116). While only a single blockchain network 116 and a single asset network 114 are illustrated in FIG. 1, it can be appreciated that any number of blockchain networks 116 and/or asset networks 114 can be a part of the multi-token network 112. Further, the multi-token network 112 is capable of communicating and transacting across various types of networks. For example, the blockchain network 116 and/or the asset network 114 may be a private, permissioned, or public blockchain network and the first financial institution 104 and the second financial institution 108 may each be a part of a separate payment network.

In an embodiment, the multi-token network 112 may include a blockchain network 116. The blockchain network 116 may be comprised of a plurality of blockchain nodes including, but not limited to, the first financial institution 104, the processing server 106, and the second financial institution 108. Each blockchain node of the blockchain network 116 may be a computing system, such as illustrated in FIG. 7, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain of the blockchain network 116 may be a distributed ledger that is comprised of at least a plurality of blocks. Each block may include at least a block header and one or more data values. Each block header may include at least a timestamp, a block reference value, and a data reference value. The timestamp may be a time at which the block header was generated and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single node in the blockchain network 116 prior to the generation and addition of a new block to the blockchain in order for the change to be made permanent. Computational and communication limitations may make such a modification exceedingly difficult, if not impossible, thus rendering the blockchain immutable.

In some embodiments, the blockchain may be used to store information regarding blockchain transactions (e.g., a transaction request for the purchase of an asset on the asset network 114) conducted between two different blockchain wallets (e.g., a buyer digital address associated with the receiving computing device 102 and a seller digital address associated with the sending computing device 110). A blockchain wallet may include a private key of a cryptographic key pair that is used to generate digital signatures that serve as authorization by a payer for a blockchain transaction, where the digital signature can be verified by the blockchain network 116 using the public key of the cryptographic key pair. In some cases, the term “blockchain wallet” or “digital address” may refer specifically to the private key. In other cases, the term “blockchain wallet” or “digital address” may refer to a computing device (e.g., the receiving computing device 102 and the sending computing device 110, etc.) that stores the private key for use thereof in blockchain transactions. For instance, each computing device may each have their own private key for respective cryptographic key pairs and may each be a blockchain wallet for use in transactions with the blockchain associated with the blockchain network 116. Computing devices may be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain may correspond to a blockchain transaction or other storage of data, as applicable. A blockchain transaction may consist of at least: a digital signature of the sender of currency or digital token (e.g., a digital address associated with the receiving computing device 102) that is generated using the sender's private key, a blockchain address of the recipient of currency or digital token (e.g., a digital address associated with the sending computing device 110) generated using the recipient's public key, and a blockchain currency amount that is transferred or other data being stored. In some blockchain transactions, the transaction may also include one or more blockchain addresses of the sender where blockchain currency or digital token is currently stored (e.g., where the digital signature proves their access to such currency or digital token), as well as an address generated using the sender's public key for any change that is to be retained by the sender. Addresses to which cryptographic currency or digital tokens have been sent that can be used in future transactions are referred to as “output” addresses, as each address was previously used to capture output of a prior blockchain transaction, also referred to as “unspent transactions,” due to there being currency or digital tokens sent to the address in a prior transaction where that currency or digital token is still unspent. In some cases, a blockchain transaction may also include the sender's public key, for use by an entity in validating the transaction. For the traditional processing of a blockchain transaction, such data may be provided to a blockchain node (e.g., the processing server 106, the first financial institution 104, and/or the second financial institution 108) in the blockchain network 116, either by the sender or the recipient. The node may verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block may be validated by other nodes in the blockchain network 116 before being added to the blockchain and distributed to all of the blockchain nodes in the blockchain network 116 in traditional blockchain implementations. In cases where a blockchain data value may not be related to a blockchain transaction, but instead the storage of other types of data, blockchain data values may still include or otherwise involve the validation of a digital signature.

In the system 100, blockchain nodes wanting to conduct a transaction using digital tokens may submit those digital tokens to the processing server 106 for facilitating the transaction through the blockchain network 116. When a receiving computing device 102 wants to purchase an asset on the asset network 114 using a digital token issued by the first financial institution 104, then the receiving computing device 102 may submit a new blockchain transaction request (e.g., an asset purchase request) to the blockchain network 116. The digital token issued by the first financial institution 104 will have a value equal to or greater than the purchase price of the asset on the asset network 114. In an exemplary embodiment, the receiving computing device 102 communicates with the blockchain network 116 via the first financial institution 104 (e.g., the financial institution that issued the digital token). The transaction request may include the digital address of the receiving computing device 102, a digital token issued by the first financial institution 104, a digital address of the sending computing device 110, an asset network 114 identification, and an asset identification. In some instances, the transaction request may include a digital signature generated using the private key of the digital address of the receiving computing device 102, which can be validated by the processing server 106 using the public key of the digital address of the receiving computing device 102, such as to validate that the receiving computing device 102 is authorized to use the digital address for which the transaction was submitted. In an embodiment, the receiving computing device 102 and/or the first financial institution 104 may transmit the transaction request directly to the processing server 106 using a traditional payment rail network (e.g., there is no blockchain network 116).

The processing server 106 may receive the transaction request and may then generate a guarantee token against the digital token (e.g., the guarantee token is generated having a value equivalent to the value of the digital token). The guarantee token is created by one or more digital addresses of the processing server 106. The guarantee token may include one or more attributes, such as, but not limited to, a unique symbol, an amount in circulation, and an exchange value, etc. In an embodiment, the processing server 106 stores the digital token in a database of the processing server 106. The processing server 106 may generate the transaction request in response to validating the digital signature of the receiving computing device 102. The guarantee token represents a tokenized guarantee of the digital token issued by the first financial institution 104 (e.g., a guarantee of the funds represented by the digital token.) For example, the guarantee token may be issued against a liability of first financial institution 104 to the processing server 106 and in turn represents a liability of the processing server 106 to any subsequent bearer of the guarantee token (e.g., the second financial institution 108 and/or the sending computing device 110, etc.). The guarantee token may be denoted in the same currency as the digital token against which it is issued. The guarantee token is a fungible asset and thus all issued guarantee tokens of the same currency and value are indistinguishable from each other. The guarantee token is minted and transferred only within the multi-token network 112 amongst registered participants in the multi-token network 112 (e.g., the receiving computing device 102, the first financial institution 104, the second financial institution 108, and the sending computing device 110, etc.). The processing server 106 may identify a smart contract on the asset network 114 (e.g., the asset network 114 and asset identified in the transaction request) and determine one or more parameters for unlocking the smart contract. In generating the guarantee token, the processing server 106 uses the one or more parameters of the smart contract associated with the asset identified in the transaction request to generate a guarantee token that will unlock that smart contract and release the asset. In an embodiment, the guarantee token may not operate to unlock a smart contract on the asset network 114, but rather, the processing server 106 may generate a payment status token for unlocking a smart contract on the asset network 114. In such embodiments, the guarantee token would not be transmitted to the asset network 114. The payment status token may be a tokenized payment authorization message of payment for an asset on the asset network 114 generated using the one or more parameters of the smart contract associated with the asset identified in the transaction request. The payment status token may include asset transaction metadata such as, but not limited to, a transaction reference, a transaction payment confirmation, the asset identification, an indication of transaction payment failure, and an indication of transaction payment delay. The asset transaction metadata can be used by the asset network 114 or any other external entity as a proof of payment, transaction verifiability, and/or reconciliation (e.g., if the asset network 114 wants to charge commission to the processing server 106). The payment status token is any suitable cryptographically verifiable messaging token such as, but not limited to, a non-fungible ERC 721 token, an ERC 20 token, etc. The processing server 106 may generate the payment status token on a private blockchain network (e.g., the blockchain network 116) and the private blockchain network may include a smart contract for transferring the payment status token from the private blockchain network to the asset network 114. The processing server 106 generates an asset request transaction for the asset on behalf of the receiving computing device 102. The asset request transaction may include, but is not limited to, the guarantee token, the receiving party digital address of the receiving computing device 102, the sending party digital address of the sending party computing device 110, and the asset identification. In some embodiments, the asset request transaction may include a digital address of the processing server 106. In some instances, the asset request transaction may include a digital signature generated using the private key of the digital address of the processing server 106 and/or the receiving computing device 102, which can be validated by the asset network 114 using the public key of the digital address of the processing server 106 and/or the receiving computing device 102, such as to validate that processing server 106 and/or the receiving computing device 102 is authorized to use the digital address for which the transaction was submitted. The processing server 106 may transmit the asset request to the blockchain network 116 for recordation therein. In an embodiment where the processing server 106 generates a payment status token, the asset request transaction includes the payment status token instead of the guarantee token and the processing server 106 may transmit the guarantee token directly to the second financial institution 108.

The asset network 114 may receive the asset request transaction from the processing server 106 and generate an asset transaction. The asset network 114 may generate the asset transaction in response to validating the digital signature of the processing server 106 and/or the receiving computing device 102. The asset transaction may include, but is not limited to, the asset, the receiving party digital address of the receiving computing device 102, the sending party digital address of the sending party computing device 110. The asset transaction may be generated by a node of the asset network 114 on behalf of the sending computing device 110 or directly by the sending computing device 110. In some embodiments, the asset transaction may include a digital address of the processing server 106. In some instances, the asset request transaction may include a digital signature generated using the private key of the digital address of the node of the asset network 114 and/or the sending computing device 110, which can be validated by the processing server 106 using the public key of the digital address of the node of the asset network 114 and/or the sending computing device 110, such as to validate that node of the asset network 114 and/or the sending computing device 110 is authorized to use the digital address for which the transaction was submitted. The asset network 114 may transmit the guarantee token received in the asset request transaction to the second financial institution 108 so that the second financial institution 108 can redeem the currency associated with the guarantee token. In some embodiments the guarantee token may be transmitted to the digital address of the sending computing device 110, which the sending computing device 110 may submit to the second financial institution 108. In embodiments where the asset network 114 receives a payment status token instead of a guarantee token as part of the asset request transaction, the asset network 114 may transmit the payment status token to the second financial institution 108. Alternatively, the asset network 114 may transmit the payment status token back to the processing server 106, keep and store the payment status token, or keep and destroy the payment status token.

The processing server 106 may receive the asset transaction from the asset network 114 (e.g., via the node of the asset network 114 and/or the sending computing device 110). The processing server 106 validate the digital signature of the node of the asset network 114 and/or the sending computing device 110 and transmit the asset transaction and/or just the asset to the digital address of the receiving computing device 102.

The processing server 106 may receive a redeem request from the second financial institution 108. The redeem request includes the guarantee token generated by the processing server 106 in response to the transaction request. The redeem request may also include a digital address of the second financial institution 108. In some instances, the redeem request may include a digital signature generated using the private key of the digital address of the second financial institution 108, which can be validated by the processing server 106 using the public key of the digital address of the second financial institution 108, such as to validate that the second financial institution 108 is authorized to use the digital address for which the transaction was submitted. The processing server 106 may generate and transmit a settlement transaction message to the first financial institution 104. The settlement transaction message may include, but is not limited to, the digital token and instructions to send a fiat currency equivalent of the digital token from the first financial institution 104 to the second financial institution 108. The settlement transaction message may also include a digital address of the processing server 106. In some instances, the settlement transaction message may include a digital signature generated using the private key of the digital address of the processing server 106, which can be validated by the first financial institution 104 using the public key of the digital address of the second processing server 106, such as to validate that the processing server 106 is authorized to use the digital address for which the transaction was submitted.

The first financial institution 104 may receive the settlement transaction message from the processing server 106 and unlock a fiat currency equivalent of the digital token and transmit that fiat currency equivalent to the second financial institution 108. In some embodiments, the first financial institution 104 may unlock and transmit the fiat currency in response to validating the digital signature of the processing server 106 in the settlement transaction message. The first financial institution 104 may transmit the fiat currency to the second financial institution 108 or otherwise settle the fiat currency owed to the second financial institution 108 using traditional payment rails and settlement methods as will be apparent to one or ordinary skill in the art.

The methods and systems discussed herein provide for a technical solution to the problem of unregulated digital currency transactions in digital currency networks that lack the features and regulations of trust traditional payment systems. By using digital tokens issued by financial institutions backed by fiat currencies and issuing guarantee tokens against those digital tokens for use in digital transactions, transacting parties are enabled to transact using digital tokens in a trusted and regulated system where the value of the digital tokens is guaranteed. For example, the methods and systems discussed herein provide for a solution to support multiple tokens on a permissioned blockchain network that enables the issuance and movement of digitized deposit tokens from banks, non-bank-issued (but regulated) stablecoins and CBDCs, all in the security and speed of a leading-edge payment network. This will enable banks and other regulated institutions to take advantage of the benefits of blockchain and tokenized assets while still operating in a regulated and trusted ecosystem. Thus, the methods and systems discussed herein provide for a solution that combines elements of traditional payment and currency settlement services with the use of digital currencies resulting in a regulated and stable digital currency network.

### Processing Server

FIG. 2 illustrates an embodiment of the processing server 106 in the system 100. It will be apparent to persons having skill in the relevant art that the embodiment of the processing server 106 illustrated in FIG. 2 is provided as illustration only and may not be exhaustive to all possible configurations of the processing server 106 suitable for performing the functions as discussed herein. For example, the computer system 700 illustrated in FIG. 7 and discussed in more detail below may be a suitable configuration of the processing server 106. In some embodiments, blockchain nodes (e.g., the first financial institution 104 and the second financial institution 108) in the blockchain network (e.g., the blockchain network 116) illustrated in FIG. 1 may include the components illustrated in the processing server 106 of FIG. 2 and be configured to perform the functions discussed herein.

The processing server 106 may include a receiving device 202. The receiving device 202 may be configured to receive data over one or more networks via one or more network protocols. In some instances, the receiving device 202 may be configured to receive data from the receiving computing device 102, the first financial institution 104, the second financial institution 108, the sending computing device 110, the asset network 114, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing server 106 to carry out the methods and systems described herein.

The receiving device 202 may be configured to receive data signals electronically transmitted by the receiving computing device 102, the first financial institution 104, the second financial institution 108, the sending computing device 110, the asset network 114, that may be superimposed or otherwise encoded with new transactions for confirmation, confirmed blockchain transactions, new blocks for confirmation, confirmed blocks for addition to the blockchain, messages regarding block confirmations, blockchain network load data, etc. The receiving device 202 may also be configured to receive data signals electronically transmitted by receiving computing device 102, the first financial institution 104, the second financial institution 108, the sending computing device 110, the asset network 114, which may be superimposed or otherwise encoded with transaction requests, new blockchain transactions, public keys, digital signatures, response messages, computational challenge responses, etc. For example, the receiving device 202 may receive the transaction request, the asset transaction, and the redeem request as discussed above.

The processing server 106 may also include a communication module 204. The communication module 204 may be configured to transmit data between modules, engines, databases, memories, and other components of the processing server 106 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 106 and external components of the processing server 106, such as externally connected databases, display devices, input devices, etc. The processing server 106 may also include a processing device. The processing device may be configured to perform the functions of the processing server 106 discussed herein as will be apparent to persons having skill in the relevant art. In some embodiments, the processing server 106 may include and/or be comprised of a plurality of engines and/or modules specially configured to perform one or more functions of the processing server 106, such as a querying module 214, generation module 216, validation module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 106 may also include a memory 208. The memory 208 may be configured to store data for use by the processing server 106 in performing the functions discussed herein, such as public and private keys, symmetric keys, etc. The memory 208 may be configured to store data using suitable data formatting methods and schema and may be any suitable type of memory, such as read-only memory, random access memory, etc. The memory 208 may include, for example, encryption keys and algorithms, communication protocols and standards, data formatting standards and protocols, program code for modules and application programs of the processing server 106, and other data that may be suitable for use by the processing server 106 in the performance of the functions disclosed herein as will be apparent to persons having skill in the relevant art. In some embodiments, the memory 208 may be comprised of or may otherwise include a relational database that utilizes structured query language for the storage, identification, modifying, updating, accessing, etc. of structured data sets stored therein. The memory 208 may be configured to store, for example, cryptographic keys, salts, nonces, address generation and validation algorithms, digital signature generation and validation algorithms, hashing algorithms for generating reference values, rules regarding generation of new blocks and block headers, a pool of pending transactions, blockchain network load information, blockchain wallet data, challenge difficulty data, etc. The memory 208 may further be configured to store communication information for the receiving computing device 102, the first financial institution 104, the second financial institution 108, the sending computing device 110, and the asset network 114. The memory 208 may further be configured to store digital coins received by the processing server 106 from the receiving computing device 102, the first financial institution 104, the second financial institution 108, the sending computing device 110, and the asset network 114.

The processing server 106 may also include blockchain data 206, which may be stored in the memory 208 of the processing server 106 or stored in a separate area within the processing server 106 or accessible thereby. The blockchain data 206 may include a blockchain, which may be comprised of a plurality of blocks and be associated with the blockchain network (e.g., the blockchain network 116). In some cases, the blockchain data 206 may further include any other data associated with the blockchain and management and performance thereof, such as block generation algorithms, digital signature generation and confirmation algorithms, collected mining bids, mining bid weighting and selection rules, etc. In some cases, the blockchain data 206 may include communication data for the receiving computing device 102, the first financial institution 104, the second financial institution 108, the sending computing device 110, and the asset network 114. In some cases, the blockchain data 206 may include data associated with blockchain wallets for use in the purchase and sale of assets on the asset network 114.

The processing server 106 may include a querying module 214. The querying module 214 may be configured to execute queries on databases to identify information. The querying module 214 may receive one or more data values or query strings and may execute a query string based thereon on an indicated database, such as the memory 208 of the processing server 106 to identify information stored therein. The querying module 214 may then output the identified information to an appropriate engine or module of the processing server 106 as necessary. The querying module 214 may, for example, execute a query on the memory 208 to identify digital coins received from the receiving computing device 102, the first financial institution 104, the second financial institution 108, the sending computing device 110, and the asset network 114. The querying module 214 may, for example query the asset network 114 to identify one or more assets and one or more smart contracts associated with the asset network 114 and/or the one or more assets.

The processing server 106 may also include a generation module 216. The generation module 216 may be configured to generate data for use by the processing server 106 in performing the functions discussed herein. The generation module 216 may receive instructions as input, may generate data based on the instructions, and may output the generated data to one or more modules of the processing server 106. For example, the generation module 216 may be configured to generate new blockchain data values, new block headers, Merkle roots, new blocks, and other data for operation of the blockchain. The generation module 216 may also be configured to generate a guarantee token against one or more digital coins received from the receiving computing device 102, the first financial institution 104, the second financial institution 108, the sending computing device 110, and the asset network 114. For example, the generation module 216 may generate a guarantee token based on a value of the digital token. Further, the generation module 216 may be configured to generate a payment status token for unlocking one or more smart contracts on the asset network 114.

The processing server 106 may also include a validation module 218. The validation module 218 may be configured to perform validations for the processing server 106 as part of the functions discussed herein. The validation module 218 may receive instructions as input, which may also include data to be used in performing a validation, may perform a validation as requested, and may output a result of the validation to another module or engine of the processing server 106. The validation module 218 may, for example, be configured to confirm blockchain transactions by analyzing blockchain data values in the blockchain to ensure that the receiving computing device 102, the first financial institution 104, the second financial institution 108, the sending computing device 110, and/or the asset network 114 are authorized to use the transaction outputs included in the new transaction submission and that the transaction outputs have not been previously used to transfer currency in another transaction. The validation module 218 may also be configured to validate digital signatures using public keys and suitable signature generation algorithms. The validation module 218 may be further configured to validate the digital tokens, the guarantee tokens, the payment status tokens, and/or the assets transacted in the system 100.

The processing server 106 may also include a transmitting device 220. The transmitting device 220 may be configured to transmit data over one or more networks via one or more network protocols. In some instances, the transmitting device 220 may be configured to transmit data to the receiving computing device 102, the first financial institution 104, the second financial institution 108, the sending computing device 110, the asset network 114, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by the receiving device 202. In some instances, the transmitting device 220 may include one or more modules for superimposing, encoding, or otherwise formatting data into data signals suitable for transmission.

The transmitting device 220 may be configured to electronically transmit data signals to the receiving computing device 102, the first financial institution 104, the second financial institution 108, the sending computing device 110, and the asset network 114 that are superimposed or otherwise encoded with new blockchain data values, new blocks for confirmation, confirmed blocks, messages regarding block or transaction confirmations, and other data used in the operation and management of the blockchain. The transmitting device 220 may also be configured to electronically transmit data signals to the receiving computing device 102, the first financial institution 104, the second financial institution 108, the sending computing device 110, the asset network 114, which may be superimposed or otherwise encoded with the asset request transaction, the asset transfer transaction, and the settlement transaction message, etc. as discussed in more detail above.

### Process for Transaction Settlement and Smart Contract Access Using Guarantee Tokens

FIGS. 3A-3G illustrate a process 300 for transaction settlement and smart contract access using guarantee tokens in accordance with exemplary embodiments.

In step 302, the receiving computing device 102 selects an asset to acquire on the asset network 114. For example, a user of the receiving computing device 102 may select an NFT for sale by the sending computing device 110 on an NFT marketplace (e.g., the asset network 114). The receiving computing device 102 generates an asset purchase request at step 304 and at step 306 transmits the asset purchase request to the first financial institution 104. The asset purchase request may include, but is not limited to, a sending party address of the sending computing device 110, an asset network 114 identification, an asset identification, and a value of the asset.

In step 308, the first financial institution 104 receives the asset purchase request from the receiving computing device 102. The first financial institution 104 may check an account associated with the receiving computing device 102 to verify that the receiving computing device 102 has a balance high enough to cover the value of the asset purchase. At step 310, the first financial institution 104 generates a transaction request including at least a receiving party digital address, a digital token issued by the first financial institution 104 to the receiving party digital address, a sending party address, an asset network identification, an asset identification and transmits the transaction request to the processing server 106 at step 312. The processing server 106 is part of the multi-token network 112, which may include a blockchain network (e.g., blockchain network 116) and the first financial institution 104 may transmit the transaction request to the blockchain network 116 at step 312.

In step 314, the processing server 106 receives the transaction request from the first financial institution 104 and generates a guarantee token against the digital token at step 318. The guarantee token including at least unique symbol, an amount in circulation, and an exchange value. In an embodiment, the processing server 106 may generate the guarantee token on a private blockchain network within the multi-token network 112. For example, the processing server 106 may be a node in a permissioned private blockchain network for generating guarantee tokens for use in the multi-token network 112. In an embodiment where the guarantee token is generated on a private blockchain network, a smart contract may be used to transfer the guarantee token between the private blockchain network and a public blockchain network (e.g., the asset network 114). The processing server 106 may receive the transaction request directly from the first financial institution 104 or the first financial institution 104 may transmit the transaction request to a blockchain network (e.g., the blockchain network 116) and the processing server 106 and any other nodes (e.g., the first financial institution 104 and the second financial institution 108) may receive the transaction request as a node in a blockchain network (e.g., the blockchain network 116) at step 316.

In step 320, the processing server 106 generates an asset request transaction. The asset request transaction includes, but is not limited to, the guarantee token, the receiving party digital address of the receiving computing device 102, the sending party digital address of the sending computing device 110, and the asset identification. The processing server 106 transmits the asset request transaction to the asset network 114 at step 322.

In step 324, the asset network 114 (e.g., one or more nodes of the asset network 114) receives the asset request from the processing server 106. The asset request may be received by a smart contract of the asset network 114 and/or associated with the asset. The asset network 114 may process the asset request and generate an asset transaction at step 326. For example, the asset network 114 may verify that the guarantee token included in the asset request is capable of unlocking the smart contract associated with the asset network 114 and/or the asset. The asset transaction includes, but is not limited to, the receiving party digital address of the receiving computing device 102 and the sending party digital address of the sending computing device 110. At step 327, the asset network 114 transmits the asset transaction to the processing server 106 and/or the blockchain network 116.

In step 328, the processing server 106 receives the asset transaction from the asset network 114. The processing server 106 may receive the asset transaction directly from a node within the asset network 114 or a node in the asset network 114 may transmit the asset transaction to a blockchain network (e.g., the blockchain network 116) and the processing server and any other nodes (e.g., the first financial institution 104 and the second financial institution 108) may receive the transaction request as a node in a blockchain network (e.g., blockchain network 116) at step 330.

In step 332, the processing server 106 generates an asset transfer transaction. The asset transfer transaction includes, but is not limited to, the receiving party digital address of the receiving computing device 102, the sending party digital address of the sending computing device 110, and the asset identification. In step 334, the processing server 106 transmits the asset transfer transaction to a blockchain network (e.g., blockchain network 116) and/or the digital address of the receiving computing device 102.

In step 336 and 337, the blockchain network 116 and the digital address of the receiving computing device 102 may receive the asset transfer transaction, respectively. Alternatively, the processing server 106 may just transmit the asset to the digital address of the receiving computing device 102 at step 338. For example, the receiving computing device 102 is not part of the blockchain network (e.g., the blockchain network 116) and the digital address of the receiving computing device 102 receives the asset at step 340.

Returning to step 326, the process 300 may also proceed to step 342 where the asset network 114 transmits the guarantee token of the asset transaction to the second financial institution 108. In an embodiment, the guarantee token is generated on a private blockchain network within the multi-token network 112, the asset network 114 may first send the guarantee token to the processing server 106 to release the guarantee token from the private blockchain network. In the embodiment where the guarantee token is generated on a private blockchain network, the processing server 106 may perform the step 342 after the guarantee token has been released from the private blockchain network. In step 344, the second financial institution 108 receives the guarantee token from the asset network 114 and generates a redeem request including the guarantee token at step 346. The second financial institution 108 transmits the redeem request to the processing server 106 at step 348.

In step 350, the processing server 106 receives the redeem request including the guarantee token from the second financial institution 108. In step 352, the processing server 106 generates a settlement transaction message. The settlement transaction message includes, but is not limited to, the digital token and instructions to send a fiat currency equivalent of the digital token from the first financial institution 104 to the second financial institution 108. The processing server 106 transmits the settlement transaction message to the first financial institution 104 at step 354.

In step 356, the first financial institution 104 receives the settlement transaction message from the processing server 106. The first financial institution 104 may validate the settlement transaction message (e.g., based on the digital token itself, or based on a digital signature of the processing server 106, etc.). In response to the settlement transaction message, at step 358, the first financial institution 104 may unlock a fiat currency amount equivalent to the digital token included in the settlement transaction message and transmit that fiat currency to the second financial institution 108 at step 360.

In step 362, the second financial institution 108 receives the fiat currency from the first financial institution 104. The second financial institution 108 may generate a notice to the processing server 106 confirming receipt of the fiat currency at step 364 and transit the notice at step 366. The processing server 106 receives the notice from the second financial institution 108 at step 368.

### Exemplary Method for Transaction Settlement and Smart Contract Access Using Guarantee Tokens

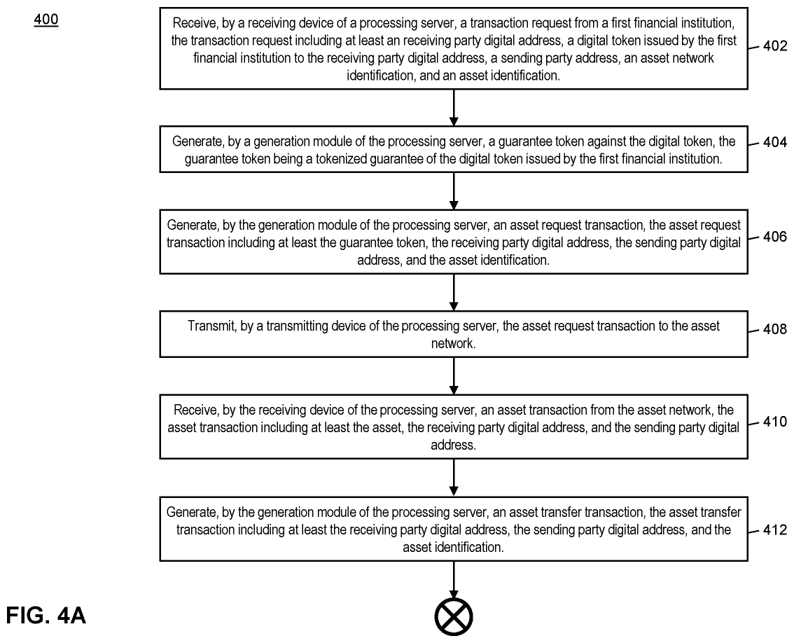

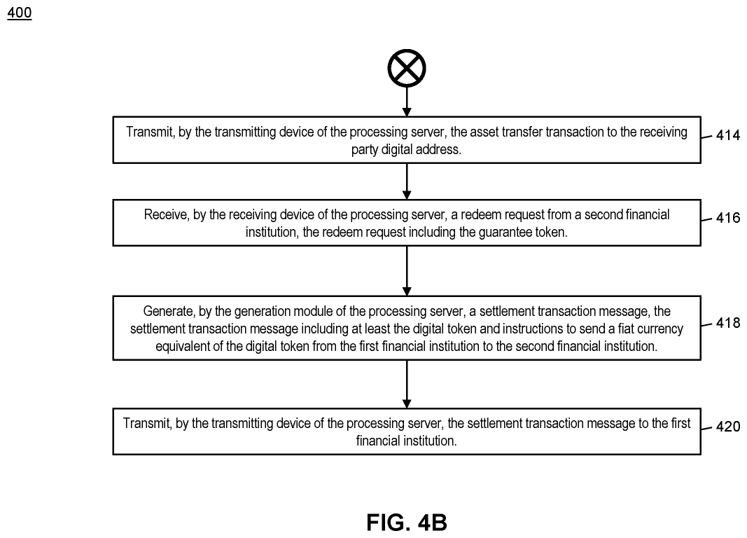

FIGS. 4A-4B illustrates a method 400 for transaction settlement and smart contract access using guarantee tokens in accordance with exemplary embodiments.

In step 402, a receiving device (e.g., the receiving device 202) of a processing server (e.g., the processing server 106) receives a transaction request from a first financial institution (e.g., the first financial institution 104). The transaction request includes at least, but is not limited to, a receiving party digital address, a digital token issued by the first financial institution (e.g., the first financial institution 104) to the receiving party digital address, a sending party address, an asset network identification (e.g., an identification of the asset network 114), and an asset identification. The digital token may be, but it not limited to, a digitized deposit token, a CBDC, or any other suitable digital coin for transacting in the system 100. The receiving party digital address, the asset network identification, the sending party digital address, and the asset identification may comprise a digital asset contract (e.g., a contract to purchase or otherwise procure the asset from the asset network 114). The asset network 114 may be a non-fungible token (NFT) marketplace and the asset may be an NFT.

In step 404, a generation module (e.g., the generation module 216) of the processing server (e.g., the processing server 106) generates a guarantee token against the digital token, the guarantee token including a processing device digital address. The guarantee token is a tokenized guarantee of the digital token issued by the first financial institution (e.g., the first financial institution 104). For example, the processing server 106 generates a guarantee token based on the value of the digital token. The guarantee token represents a legal claim against the processing server 106 for the value of the digital token. The processing server 106 may identify (e.g., using the querying module 214) an asset smart contract on the asset network 114 associated with the asset. The asset smart contract may include one or more asset purchase requirements for the asset. In generating the guarantee token, the processing server 106 may utilize the one or more requirements of the smart contract such that the guarantee token unlocks the asset from the asset network 114.

In step 406, the generation module (e.g., the generation module 216) of the processing server (e.g., the processing server 106) generates an asset request transaction. The asset request transaction includes at least, but is not limited to, the guarantee token, the receiving party digital address (e.g., the digital address of the receiving computing device 102), the sending party digital address (e.g., the digital address of the sending computing device 110), and the asset identification. In step 408, a transmitting device (e.g., the transmitting device 220) of the processing server (e.g., the processing server 106) transmits the asset request transaction to the asset network (e.g., the asset network 114). The processing server 106 may transmit the asset request transaction directly to the asset network 114 or the processing server 106 may transmit the asset request transaction to a blockchain network (e.g., the blockchain network 116) and a node in the asset network 114 and any other nodes of the blockchain network 116 may receive the asset request transaction as a node in a blockchain network 116.

In step 410, the receiving device (e.g., the receiving device 202) of the processing server (e.g., the processing server 106) receives an asset transaction from the asset network (e.g., a node of the asset network 114 and/or the sending computing device 110). The asset transaction includes at least, but it not limited to, the receiving party digital address (e.g., the digital address of the receiving computing device 102), and the sending party digital address (e.g., the digital address of the sending computing device 110). In some embodiments, the asset transaction may be received by a smart contract on the processing server 106.

In step 412, the generation module (e.g., the generation module 216) of the processing server (e.g., the processing server 106) generates an asset transfer transaction. The asset transfer transaction includes at least, but is not limited to, the receiving party digital address (e.g., the digital address of the receiving computing device 102), the sending party digital address (e.g., the digital address of the sending computing device 110), and the asset identification. In step 414, the transmitting device (e.g., the transmitting device 220) of the processing server (e.g., the processing server 106) transmits the asset transfer transaction to the receiving party digital address (e.g., the digital address of the receiving computing device 102). In an embodiment, the processing server 106 may only transmit the asset instead of the entire asset transfer transaction. In some embodiments, the asset transfer transaction may be generated via a smart contract on the processing server 106.

In step 416, the receiving device (e.g., the receiving device 202) of the processing server (e.g., the processing server 106) receives a redeem request from a second financial institution (e.g., the second financial institution 108). The redeem request includes at least the guarantee token (e.g., the guarantee token generated by the processing server 106 in step 404). In response to receiving the guarantee token, the generation module (e.g., the generation module 216) of the processing server (e.g., the processing server 106) generates a settlement transaction message at step 418. The settlement transaction message includes at least, but is not limited to, the digitized deposit token (e.g., the digital token issued by the first financial institution 104) and instructions to send a fiat currency equivalent of the digitized deposit token from the first financial institution (e.g., the first financial institution 104) to the second financial institution (e.g., the second financial institution 108).

In step 420, the transmitting device (e.g., the transmitting device 220) of the processing server (e.g., the processing server 106) transmits the settlement transaction message to the first financial institution (e.g., the first financial institution 104). The settlement transaction message may be received and transmitted by the processing server 106 using a smart contract.

### Process for Transaction Settlement and Smart Contract Access Using Guarantee Tokens and Payment Status Tokens

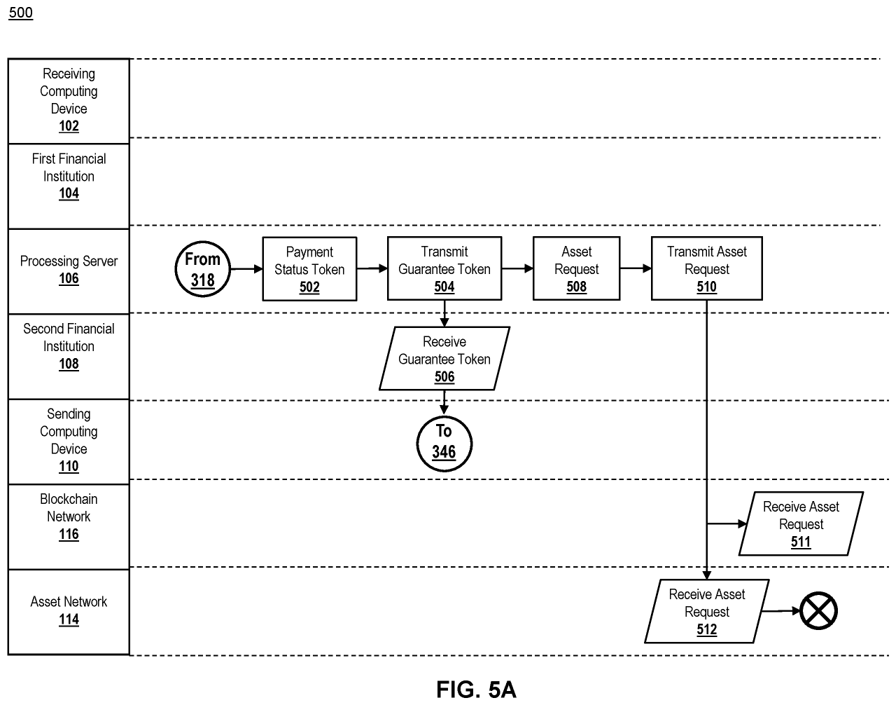

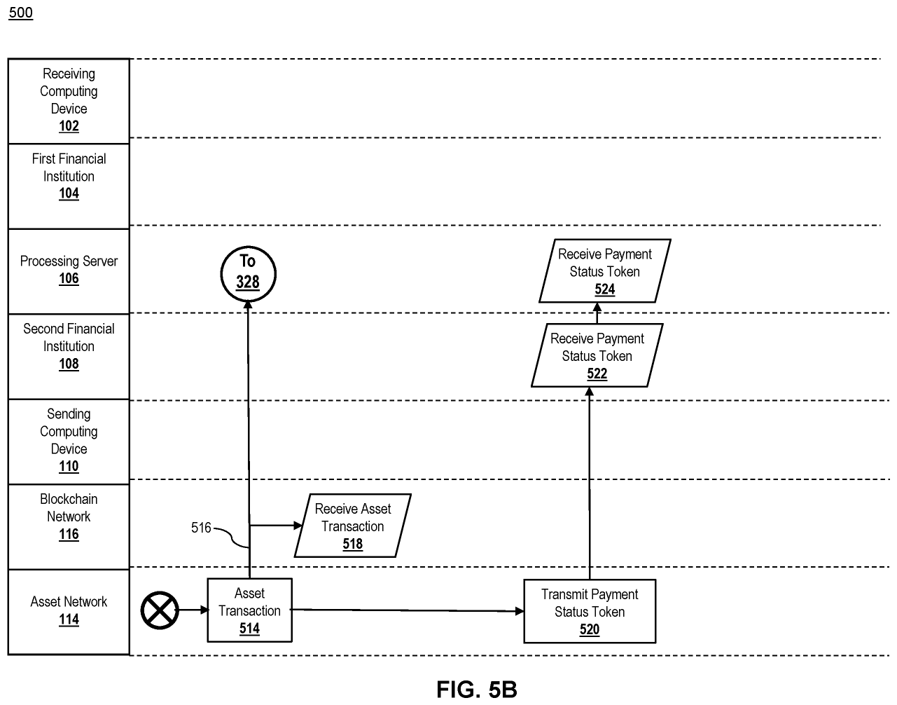

FIGS. 5A-5B illustrate a process 500 for transaction settlement and smart contract access using guarantee tokens and payment status tokens in accordance with exemplary embodiments. The process 500 shares steps 302-318 of the process 300 and proceeds from step 318 to step 502. The process 500 decouples the tokenized guarantee of the digital token issued by the first financial institution and the smart contract functions of the guarantee token. In the process 500, the guarantee token functions as a tokenized guarantee of the digital token issued by the first financial institution and a payment status token functions to unlock a smart contract on the asset network 114 associated with one or more assets. In the process 500, the guarantee token is not transmitted to the asset network 114.

In step 502, the processing server 106 generates a payment status token. The payment status token includes asset transaction metadata. The asset transaction metadata includes one or more of, but is not limited to, a transaction reference, a transaction payment confirmation, the asset identification, an indication of transaction payment failure, and an indication of transaction payment delay. The asset transaction metadata can be used by the asset network 114 or any other external entity as a proof of payment, transaction verifiability, and/or reconciliation (e.g., if the asset network 114 wants to charge commission to the processing server 106). The payment status token is any suitable cryptographically verifiable messaging token such as, but not limited to, a non-fungible ERC 721 token, an ERC 20 token, etc.

In step 504, the processing server 106 transmits the guarantee token (e.g., the guarantee token generated at step 318) to the second financial institution 108. The second financial institution 108 receives the guarantee token from the processing server 106 at step 506. From the step 506, the process 500 proceeds to steps 346-368 of the process 300.

In step 508, the processing server 106 generates an asset request transaction. The asset request transaction includes, but is not limited to, the payment status token, the receiving party digital address of the receiving computing device 102, the sending party digital address of the sending computing device 110, and the asset identification. The processing server 106 transmits the asset request transaction to the asset network 114 at step 510.

In step 512, the asset network 114 (e.g., one or more nodes of the asset network 114) receives the asset request from the processing server 106. The asset request may be received by a smart contract of the asset network 114 and/or associated with the asset. The asset network 114 may receive the asset request directly from the processing server 106 or the processing server 106 may transmit the asset request to a blockchain network at step 511 (e.g., the blockchain network 116) and a node in the asset network 114 and any other nodes of the blockchain network 116 may receive the asset request as a node in a blockchain network 116 at step 512.

The asset network 114 may process the asset request and generate an asset transaction at step 514. For example, the asset network 114 may verify that the payment status token included in the asset request is capable of unlocking the smart contract associated with the asset network 114 and/or the asset. The asset transaction includes, but is not limited to, the receiving party digital address of the receiving computing device 102 and the sending party digital address of the sending computing device 110. At step 516, the asset network 114 transmits the asset transaction to the processing server 106 and/or the blockchain network 116. At step 518, the blockchain network 116 receives the asset transaction from the asset network 114. From the step 516, the process 500 proceeds to the steps 328-340 of the process 300.

From the step 514, the process 500 may proceed to the step 520 where the asset network 114 transmits the payment status token to the second financial institution 108 (at step 522) and/or the processing server 106 (at step 524). The second financial institution 108 and/or the processing server 106 may receive the payment status token directly from the asset network 114 or the asset network 114 may transmit the payment status token to a blockchain network (e.g., the blockchain network 116) and the second financial institution 108 and/or the processing server 106 and any other nodes of the blockchain network 116 may receive the payment status token as a node in a blockchain network 116. Steps 520-524 are optional in the process 500 and the asset network 114 may retain the payment status token. In an embodiment, steps 520-524 may occur simultaneously or sequentially with the steps 504-368.

### Exemplary Method for Transaction Settlement and Smart Contract Access Using Guarantee Tokens and Payment Status Tokens

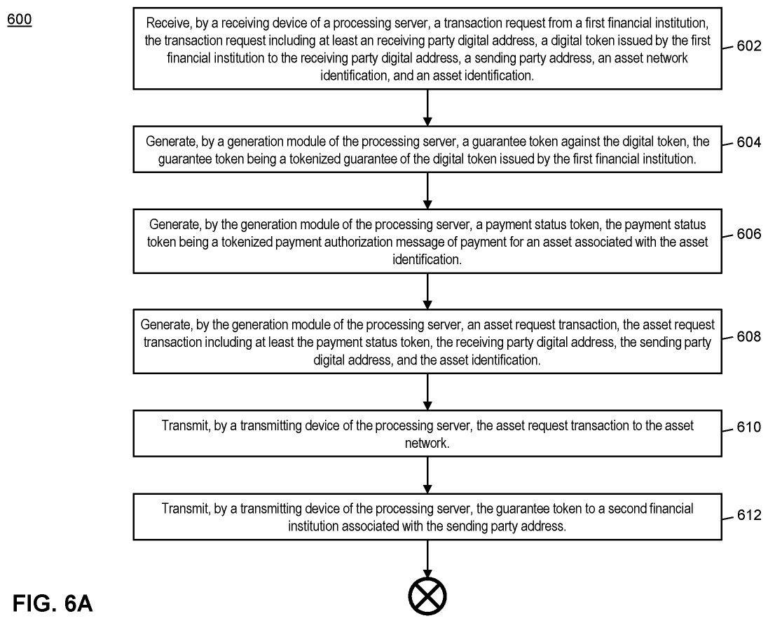

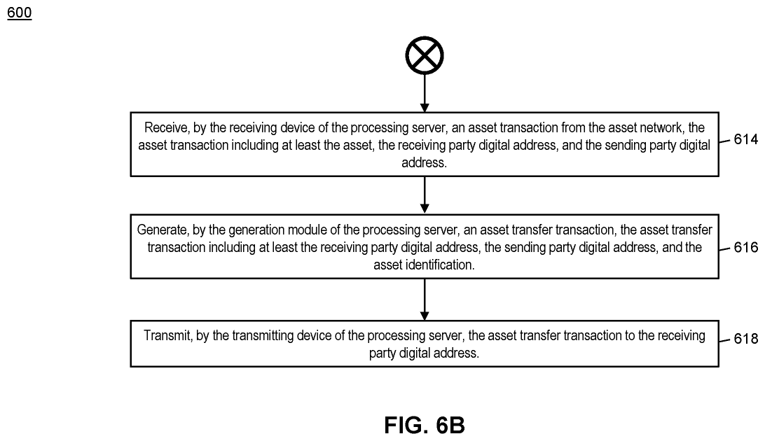

FIGS. 6A-6B illustrates a method 600 for transaction settlement and smart contract access using guarantee tokens and payment status tokens in accordance with exemplary embodiments.

In step 602, a receiving device (e.g., the receiving device 202) of a processing server (e.g., the processing server 106) receives a transaction request from a first financial institution (e.g., the first financial institution 104). The transaction request includes at least, but is not limited to, a receiving party digital address, a digital token issued by the first financial institution (e.g., the first financial institution 104) to the receiving party digital address, a sending party address, an asset network identification (e.g., an identification of the asset network 114), and an asset identification. The digital token may be, but it not limited to, a digitized deposit token, a CBDC, or any other suitable digital coin for transacting in the system 100. The receiving party digital address, the asset network identification, the sending party digital address, and the asset identification may comprise a digital asset contract (e.g., a contract to purchase or otherwise procure the asset from the asset network 114). The asset network 114 may be a non-fungible token (NFT) marketplace and the asset may be an NFT.

In step 604, a generation module (e.g., the generation module 216) of the processing server (e.g., the processing server 106) generates a guarantee token against the digital token, the guarantee token including a processing device digital address. The guarantee token is a tokenized guarantee of the digital token issued by the first financial institution (e.g., the first financial institution 104). For example, the processing server 106 generates a guarantee token based on the value of the digital token. The guarantee token represents a legal claim against the processing server 106 for the value of the digital token. The processing server 106 may identify (e.g., using the querying module 214) an asset smart contract on the asset network 114 associated with the asset. The asset smart contract may include one or more asset purchase requirements for the asset. In generating the guarantee token, the processing server 106 may utilize the one or more requirements of the smart contract such that the guarantee token unlocks the asset from the asset network 114.

In step 606, the generation module (e.g., the generation module 216) of the processing server (e.g., the processing server 106) generates a payment status token. The payment status token is a tokenized payment authorization message of payment for an asset associated with the asset identification (e.g., the asset identification of the transaction request). The payment status token includes asset transaction metadata. The asset transaction metadata includes one or more of, but is not limited to, a transaction reference, a transaction payment confirmation, the asset identification, an indication of transaction payment failure, and an indication of transaction payment delay. The asset transaction metadata can be used by the asset network 114 or any other external entity as a proof of payment, transaction verifiability, and/or reconciliation (e.g., if the asset network 114 wants to charge commission to the processing server 106). The payment status token is any suitable cryptographically verifiable messaging token such as, but not limited to, a non-fungible ERC 721 token, an ERC 20 token, etc. The processing server 106 may generate the payment status token on a private blockchain network (e.g., the blockchain network 116) and the private blockchain network may include a smart contract for transferring the payment status token from the private blockchain network to the asset network 114 as described in step 610 below.

In step 608, the generation module (e.g., the generation module 216) of the processing server (e.g., the processing server 106) generates an asset request transaction. The asset request transaction includes at least, but is not limited to, the payment status token, the receiving party digital address (e.g., the digital address of the receiving computing device 102), the sending party digital address (e.g., the digital address of the sending computing device 110), and the asset identification.

In step 610, a transmitting device (e.g., the transmitting device 220) of the processing server (e.g., the processing server 106) transmits the asset request transaction to the asset network (e.g., the asset network 114). The processing server 106 may transmit the asset request transaction directly to the asset network 114 or the processing server 106 may transmit the asset request transaction to a blockchain network (e.g., the blockchain network 116) and a node in the asset network 114 and any other nodes of the blockchain network 116 may receive the asset request transaction as a node in a blockchain network 116.

In step 612, the transmitting device (e.g., the transmitting device 220) of the processing server (e.g., the processing server 106) transmits the guarantee token to a second financial institution (e.g., the second financial institution 108) associated with the sending party address (e.g., the digital address of the sending computing device 110).

In step 614, the receiving device (e.g., the receiving device 202) of the processing server (e.g., the processing server 106) receives an asset transaction from the asset network (e.g., a node of the asset network 114 and/or the sending computing device 110). The asset transaction includes at least, but is not limited to, the asset, the receiving party digital address (e.g., the digital address of the receiving computing device 102), and the sending party digital address (e.g., the digital address of the sending computing device 110). In some embodiments, the asset transaction may be received by a smart contract on the processing server 106. In some embodiments, the asset transaction may include the payment status token. For example, once the asset network 114 has used the payment status token to confirm that payment has been made for an asset on the asset network 114, the asset network 114 returns the payment status token to the processing server 106. Alternatively, the asset network 114 may transmit the payment status token to the second financial institution 108 or the asset network 114 may keep and store or keep and destroy the payment status token.

In step 616, the generation module (e.g., the generation module 216) of the processing server (e.g., the processing server 106) generates an asset transfer transaction. The asset transfer transaction includes at least, but is not limited to, the receiving party digital address (e.g., the digital address of the receiving computing device 102), the sending party digital address (e.g., the digital address of the sending computing device 110), and the asset identification. In step 618, the transmitting device (e.g., the transmitting device 220) of the processing server (e.g., the processing server 106) transmits the asset transfer transaction to the receiving party digital address (e.g., the digital address of the receiving computing device 102). In an embodiment, the processing server 106 may only transmit the asset instead of the entire asset transfer transaction. In some embodiments, the asset transfer transaction may be generated via a smart contract on the processing server 106.

From the step 618, the process 600 may proceed to steps 416-420 of the process 400.

### Computer System Architecture

FIG. 7 illustrates a computer system 700 in which embodiments of the present disclosure, or portions thereof, may be implemented as computer-readable code. For example, the processing server 106 and blockchain nodes within the blockchain network 116 of FIG. 1 and the processing server 106 of FIG. 2 may be implemented in the computer system 700 using hardware, non-transitory computer readable media having instructions stored thereon, or a combination thereof and may be implemented in one or more computer systems or other processing systems. Hardware may embody modules and components used to implement the methods of FIGS. 3A-6B.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above-described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general-purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3A-6B as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower-level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower-level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for generating a digital three-dimensional representation of a dental object during scanning with a dental imaging device. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter. It will be appreciated by those skilled in the art that the present disclosure can be embodied in other specific forms without departing from the spirit or essential characteristics thereof. The presently disclosed embodiments are therefore considered in all respects to be illustrative and not restrictive. The scope of the disclosure is indicated by the appended claims rather than the foregoing description, and all changes that come within the meaning, range, and equivalence thereof are intended to be embraced therein.

What is claimed is:

1. A method for transaction settlement using guarantee tokens, the method comprising:
receiving, by a receiving device of a processing server, a transaction request from a first financial institution, the transaction request including at least an receiving party digital address, a digital token issued by the first financial institution to the receiving party digital address, a sending party address, an asset network identification, and an asset identification;
generating, by a generation module of the processing server, a guarantee token against the digital token, the guarantee token being a tokenized guarantee of the digital token issued by the first financial institution;
generating, by the generation module of the processing server, an asset request transaction, the asset request transaction including at least the guarantee token, the receiving party digital address, the sending party digital address, and the asset identification;
transmitting, by a transmitting device of the processing server, the asset request transaction to the asset network;
receiving, by the receiving device of the processing server, an asset transaction from the asset network, the asset transaction including at least the asset, the receiving party digital address, and the sending party digital address;
generating, by the generation module of the processing server, an asset transfer transaction, the asset transfer transaction including at least the receiving party digital address, the sending party digital address, and the asset identification; and
transmitting, by the transmitting device of the processing server, the asset transaction to the receiving party digital address.

2. The method of claim 1, wherein the processing server, the first financial institution, and the second financial institution are part of a blockchain network, and wherein the transaction request, the asset request transaction, the asset transaction, and the asset transfer transaction are recorded on a blockchain of the blockchain network.

3. The method of claim of claim 1, further comprising:
receiving, by the receiving device of the processing server, a redeem request from a second financial institution, the redeem request including the guarantee token;
generating, by the generation module of the processing server, a settlement transaction message, the settlement transaction message including at least the digital token and instructions to send a fiat currency equivalent of the digital token from the first financial institution to the second financial institution; and
transmitting, by the transmitting device of the processing server, the settlement transaction message to the first financial institution.

4. The method of claim 3, wherein the digital token is a digitized deposit token.

5. The method of claim 1, wherein the processing server generates the guarantee token on a private blockchain network and wherein the private blockchain network includes a smart contract for transferring the guarantee token from the private blockchain network to the asset network.

6. The method of claim 1, wherein the receiving party digital address, the asset network identification, the sending party digital address, and the asset identification comprise a digital asset contract.

7. The method of claim 1, wherein the transmitting the asset request transaction to the asset network includes transmitting the asset request transaction to a smart contract on the asset network.

8. The method of claim 1, wherein the asset network is a non-fungible token (NFT) marketplace and wherein the asset is an NFT.

9. The method of claim 1, wherein the receiving of the asset from the asset network and the transmitting the asset to the receiving party digital address are executed by the processing server using a smart contract.

10. The method of claim 1, further comprising:
identifying, by the processing server, an asset smart contract on the asset network, the asset smart contract having one or more asset purchase requirements; and
wherein the guarantee token is generated to unlock the asset smart contract.

11. A system for transaction settlement using guarantee tokens, the method comprising:
a receiving device of a processing server receiving a transaction request from a first financial institution, the transaction request including at least an receiving party digital address, a digital token issued by the first financial institution to the receiving party digital address, a sending party digital address, an asset network identification, and an asset identification;
a generation module of the processing server generating a guarantee token against the digital token, the guarantee token being a tokenized guarantee of the digital token issued by the first financial institution;
the generation module of the processing server generating an asset request transaction, the asset request transaction including at least the guarantee token, the receiving party digital address, the sending party digital address, and the asset identification;
a transmitting device of the processing server transmitting the asset request transaction to the asset network;
the receiving device of the processing server receiving an asset transaction from the asset network, the asset transaction including at least the asset, the receiving party digital address, and the sending party digital address;
the generation module of the processing server generating an asset transfer transaction, the asset transfer transaction including at least the receiving party digital address, the sending party digital address, and the asset identification; and
the transmitting device of the processing server transmitting the asset transaction to the receiving party digital address.

12. The system of claim 11, wherein the processing server, the first financial institution, and the second financial institution are part of a blockchain network, and wherein the transaction request, the asset request transaction, the asset transaction, and the asset transfer transaction are recorded on a blockchain of the blockchain network.

13. The system of claim 11, further comprising:
the receiving device of the processing server receiving a redeem request from a second financial institution, the redeem request including the guarantee token;
the generation module of the processing server generating a settlement transaction message, the settlement transaction message including at least the digital token and instructions to send a fiat currency equivalent of the digital token from the first financial institution to the second financial institution; and
the transmitting device of the processing server transmitting the settlement transaction message to the first financial institution.

14. The system of claim 13, wherein the digital token is a digitized deposit token.

15. The system of claim 11, wherein the processing server generates the guarantee token on a private blockchain network and wherein the private blockchain network includes a smart contract for transferring the guarantee token from the private blockchain network to the asset network.

16. The system of claim 11, wherein the receiving party digital address, the asset network identification, the sending party digital address, and the asset identification comprise a digital asset contract.

17. The system of claim 11, wherein the transmitting the asset request transaction to the asset network includes transmitting the asset request transaction to a smart contract on the asset network.

18. The system of claim 11, wherein the asset network is a non-fungible token (NFT) marketplace and wherein the asset is an NFT.

19. The system of claim 11, wherein the receiving of the asset from the asset network and the transmitting the asset to the receiving party digital address are executed by the processing server using a smart contract.

20. The system of claim 11, further comprising:
the processing server identifying an asset smart contract on the asset network, the asset smart contract having one or more asset purchase requirements; and
wherein the guarantee token is generated to unlock the asset smart contract.

21. A method for transaction settlement using guarantee tokens and payment status tokens, the method comprising:
receiving, by a receiving device of a processing server, a transaction request from a first financial institution, the transaction request including at least an receiving party digital address, a digital token issued by the first financial institution to the receiving party digital address, a sending party address, an asset network identification, and an asset identification;
generating, by a generation module of the processing server, a guarantee token against the digital token, the guarantee token being a tokenized guarantee of the digital token issued by the first financial institution;
generating, by the generation module of the processing server, a payment status token, the payment status token being a tokenized payment authorization message of payment for an asset associated with the asset identification;
generating, by the generation module of the processing server, an asset request transaction, the asset request transaction including at least the payment status token, the receiving party digital address, the sending party digital address, and the asset identification;
transmitting, by a transmitting device of the processing server, the asset request transaction to the asset network;
transmitting, by the transmitting device of the processing server, the guarantee token to a second financial institution associated with the sending party address;
receiving, by the receiving device of the processing server, an asset transaction from the asset network, the asset transaction including at least the asset, the receiving party digital address, and the sending party digital address;
generating, by the generation module of the processing server, an asset transfer transaction, the asset transfer transaction including at least the receiving party digital address, the sending party digital address, and the asset identification; and
transmitting, by the transmitting device of the processing server, the asset transaction to the receiving party digital address.

22. The method of claim 21, wherein the asset transaction further includes the payment status token.

23. The method of claim 21, wherein the processing server, the first financial institution, and the second financial institution are part of a blockchain network, and wherein the transaction request, the asset request transaction, the asset transaction, and the asset transfer transaction are recorded on a blockchain of the blockchain network.

24. The method of claim 21, wherein the processing server generates the payment status token on a private blockchain network and wherein the private blockchain network includes a smart contract for transferring the payment status token from the private blockchain network to the asset network.

25. The method of claim 21, wherein the transmitting the asset request transaction to the asset network includes transmitting the asset request transaction to a smart contract on the asset network and the payment status token unlocks the smart contract on the asset network.

26. The method of claim 21, wherein the payment status token includes asset transaction metadata, the asset transaction metadata including one or more of: a transaction reference, a transaction payment confirmation, the asset identification, an indication of transaction payment failure, and an indication of transaction payment delay.

27. The method of claim 21, wherein the payment status token is a non-fungible ERC-721 token.

28. A system for transaction settlement using guarantee tokens and payment status tokens, the method comprising:
a receiving device of a processing server receiving a transaction request from a first financial institution, the transaction request including at least an receiving party digital address, a digital token issued by the first financial institution to the receiving party digital address, a sending party digital address, an asset network identification, and an asset identification;
a generation module of the processing server generating a guarantee token against the digital token, the guarantee token being a tokenized guarantee of the digital token issued by the first financial institution;
the generation module of the processing server generating a payment status token, the payment status token being a tokenized payment authorization message of payment for an asset associated with the asset identification;
the generation module of the processing server generating an asset request transaction, the asset request transaction including at least the payment status token, the receiving party digital address, the sending party digital address, and the asset identification;
a transmitting device of the processing server transmitting the asset request transaction to the asset network;
the transmitting device of the processing server transmitting the guarantee token to a second financial institution associated with the sending party address;
the receiving device of the processing server receiving an asset transaction from the asset network, the asset transaction including at least the asset, the receiving party digital address, and the sending party digital address;
the generation module of the processing server generating an asset transfer transaction, the asset transfer transaction including at least the receiving party digital address, the sending party digital address, and the asset identification; and
the transmitting device of the processing server transmitting the asset transaction to the receiving party digital address.

29. The system of claim 28, wherein the asset transaction further includes the payment status token.

30. The system of claim 28, wherein the processing server, the first financial institution, and the second financial institution are part of a blockchain network, and wherein the transaction request, the asset request transaction, the asset transaction, and the asset transfer transaction are recorded on a blockchain of the blockchain network.

31. The system of claim 28, wherein the processing server generates the payment status token on a private blockchain network and wherein the private blockchain network includes a smart contract for transferring the payment status token from the private blockchain network to the asset network.

32. The system of claim 28, wherein the transmitting the asset request transaction to the asset network includes transmitting the asset request transaction to a smart contract on the asset network and the payment status token unlocks the smart contract on the asset network.

33. The system of claim 28, wherein the payment status token includes asset transaction metadata, the asset transaction metadata including one or more of: a transaction reference, a transaction payment confirmation, the asset identification, an indication of transaction payment failure, and an indication of transaction payment delay.

34. The system of claim 28, wherein the payment status token is a non-fungible ERC-721 token.
